(19) United States
(12) Patent Application Publication
(10) Pub. No.: US 2025/0377812 A1
(43) Pub. Date: Dec. 11, 2025

(54) EFFICIENCY AND POWER CONTROL OF TASKS HAVING COMPUTATION BOUND AND MEMORY BOUND PHASES

(71) Applicant: APPLE INC., Cupetino, CA (US)

(72) Inventors: Karthic A. Palaniappan, Cupertino, CA (US); Bryan R. Hinch, Campbell, CA (US); Ronit Banerjee, Mountain View, CA (US); Timothy J. Detwiler, Cupertino, CA (US); John G. Dorsey, San Francisco, CA (US)

(73) Assignee: APPLE INC., Cupertino, CA (US)

(21) Appl. No.: 19/228,419

(22) Filed: Jun. 4, 2025

Related U.S. Application Data
(60) Provisional application No. 63/657,897, filed on Jun. 9, 2024.

(51) Int. Cl. G06F 3/06

(52) U.S. Cl. CPC G06F 3/0625; G06F 3/0659; G06F 3/0673

(57) ABSTRACT

The present disclosure describes a system that can include a memory device storing data for operations of a task, a controller to control the operations of the task, and further include a computation engine to perform the computations of the task, where the task can include multiple sets of operations. In some embodiments, the controller can determine an efficiency control metric of a set of operations based on one or more operational parameters of the memory device or the computation engine measured in a time period. Based on the efficiency control metric, the controller can identify that the set of operations of the task is associated with the computation bound phase or the memory bound phase of the task. The controller can adaptively control the computation engine to an efficient operating point to achieve a desired power performance tradeoffs for performing the set of operations of the task.

### CROSS-REFERENCE TO RELATED APPLICATIONS

This application claims the benefit of U.S. Provisional Patent Application No. 63/657,897, filed Jun. 9, 2024, the contents of which are incorporated herein by reference in its entirety.

### FIELD

The present disclosure relates to efficiency and power control for execution of tasks having computation bound and memory bound phases.

### BACKGROUND

Applications and tasks, such as artificial intelligence (AI) applications, machine learning algorithms, and image signal processing, can have computation bound and memory bound phases. During the computation bound phase, operations (e.g., mathematical operations) can be performed by multiply accumulate (MAC) units or other arithmetic or logic units. During the memory bound phase, data stored in memory devices can be accessed for computations.

### SUMMARY

Embodiments of the present disclosure include systems and methods for efficiency and power control of an execution of tasks having computation bound and memory bound phases. Embodiments herein can identify different execution phases at runtime and dynamically adjust system operating points or operating states based on whether the execution of the task is in the computation bound phase or memory bound phase and further in response to adjust available system resources to achieve the desired power performance tradeoffs.

In some embodiments, a device can include a memory device, a computation engine, and a controller coupled to the memory device and the computation engine. The memory device can be configured to store data for a task including a first set of operations being performed at a first time period and a second set of operations being performed at a second time period. The computation engine can be configured to perform operations of the task including the first set of operations and the second set of operations. The controller can be configured to determine a first efficiency control metric of the first set of operations or a second efficiency control metric of the second set of operations based on one or more operational parameters of the memory device or the computation engine measured in the first time period or the second time period, respectively. Furthermore, the controller can determine, based on the first efficiency control metric or the second efficiency control metric, that the first set of operations is associated with a computation bound phase of the task and the second set of operations is associated with a memory bound phase of the task. The controller can determine a first operating point and a second operating point of the computation engine, where the computation engine is configured to perform the first set of operations under the first operating point during the first time period and perform the second set of operations under the second operating point during the second time period.

In some embodiments, a controller can perform a method to determine an operating point of a computation engine. The method can include determining, by the controller, a first efficiency control metric of a first set of operations being performed in a first time period based on one or more operational parameters of a memory device or a computation engine; and determining a second efficiency control metric of a second set of operations being performed in a second time period based on the one or more operational parameters of the memory device or the computation engine. In some embodiments, the memory device can be configured to store data for a task including the first set of operations and the second set of operations, and the computation engine can be coupled to the memory device and configured to perform operations of the task. In addition, the method can include determining, based on the first efficiency control metric or the second efficiency control metric, that the first set of operations is associated with a computation bound phase of the task and the second set of operations is associated with a memory bound phase of the task. Furthermore, the method can include determining a first operating point and a second operating point of the computation engine. The computation engine is configured to perform the first set of operations under the first operating point during the first time period and perform the second set of operations under the second operating point during the second time period.

In some embodiments, a system can include a memory device, a computation engine coupled to the memory device, and a controller coupled to the memory device and the computation engine. The memory device can be configured to store data for a task including a first set of operations being performed at a first time period and a second set of operations being performed at a second time period. The computation engine can be configured to perform operations of the task including the first set of operations and the second set of operations. The computation engine can include a communication fabric, one or more memory controllers configured to control the memory device, a local memory, and a plurality of neural engine circuits configured to perform the operations of the task. Furthermore, the controller can be configured to determine a first efficiency control metric of the first set of operations or a second efficiency control metric of the second set of operations based on one or more operational parameters of the memory device or the computation engine measured in the first time period or the second time period, respectively. The controller can further determine, based on the first efficiency control metric or the second efficiency control metric, that the first set of operations is associated with a computation bound phase of the task and the second set of operations is associated with a memory bound phase of the task. In addition, the controller can determine a first operating point and a second operating point of the computation engine. The computation engine can be configured to perform the first set of operations under the first operating point during the first time period and perform the second set of operations under the second operating point during the second time period.

### BRIEF DESCRIPTION OF THE DRAWINGS

Aspects of the present disclosure are best understood from the following detailed description when read with the accompanying figures. It is noted that, according to the standard practice in the industry, various features are not drawn to scale. In fact, the dimensions of the various features may be arbitrarily increased or reduced for clarity of discussion.

FIGS. 1A-1B are illustrations of a device including a computation engine for execution of a task having computation bound and memory bound phases, according to some embodiments.

FIGS. 2-3 are illustrations of a computation engine for execution of a task having computation bound and memory bound phases, according to some embodiments.

FIGS. 4A-4B are illustrations of relationships between performance and power consumption for the execution of tasks, according to some embodiments.

FIG. 5 is a process executed by a controller for controlling power performance tradeoffs for a task having computation bound and memory bound phases, according to some embodiments.

FIGS. 6A-6B are systems for computing an efficiency control metric and target performance adjustment for controlling power performance tradeoffs for a task having computation bound and memory bound phases, according to some embodiments.

FIG. 7 is an illustration of a method for controlling power performance tradeoffs for a task having computation bound and memory bound phases, according to some embodiments.

FIG. 8 is an illustration of exemplary computer system for implementing some aspects or portion(s) thereof of the disclosure provided herein, according to some embodiments.

FIG. 9 is an illustration of exemplary systems or devices that can include the disclosed embodiments.

### DETAILED DESCRIPTION

The following disclosure provides many different embodiments, or examples, for implementing different features of the provided subject matter. Specific examples of components and arrangements are described below to simplify the present disclosure. These are merely examples and are not intended to be limiting. In addition, the present disclosure repeats reference numerals and/or letters in the various examples. This repetition is for the purpose of simplicity and clarity and, unless indicated otherwise, does not in itself dictate a relationship between the various embodiments and/or configurations discussed.

Embodiments of the present disclosure include systems and methods for efficiency and power control of an execution of a task having computation bound and memory bound phases. Embodiments herein can identify different execution phases of the task and dynamically adjust operating points or operating states based on whether the execution of the task is in the computation bound phase or memory bound phase. A computation bound phase or a memory bound phase can be a period of time for executing a set of operations that are intensive in computation or intensive in memory access, respectively. In some embodiments, a time period for the computation bound phase and a time period for the memory bound phase can be equal, and a controller can periodically determine an efficiency control metric of a set of operations of a task to determine the set of operations to be in the computation bound phase or the memory bound phase.

In some embodiments, a system can include a memory device storing data for the computation of the task, a controller to control the operation of the task, and a computation engine to perform the computation of the task. In some embodiments, the controller can determine an efficiency control metric of a set of operations of the task based on one or more operational parameters of the memory device or the computation engine measured in a time period. Based on the efficiency control metric for the set of operations of the task, the controller can determine whether the set of operations is associated with a computation bound phase of the task or associated with a memory bound phase of the task. In some embodiments, the controller can determine an efficiency control metric that scales with available system bandwidth and adaptively controls the computation engine of the device to an efficient operating point to achieve desired power performance tradeoffs.

In some embodiments, energy can be saved by running the set of operations of a task as fast as the set of operations can be executed, but not faster than that. In some embodiments, a task can include a set of smaller tasks, where each smaller task includes a set of operations. A task can also be referred to as a workload while a smaller task can be referred to as an atomic task or simply a set of operations. In some embodiments, an entire atomic task or a set of operations can be performed or executed in a computation bound phase where the computation engine is operated at a first operating point, or in a memory bound phase where the computation engine is operated at a second operating point, but not in both.

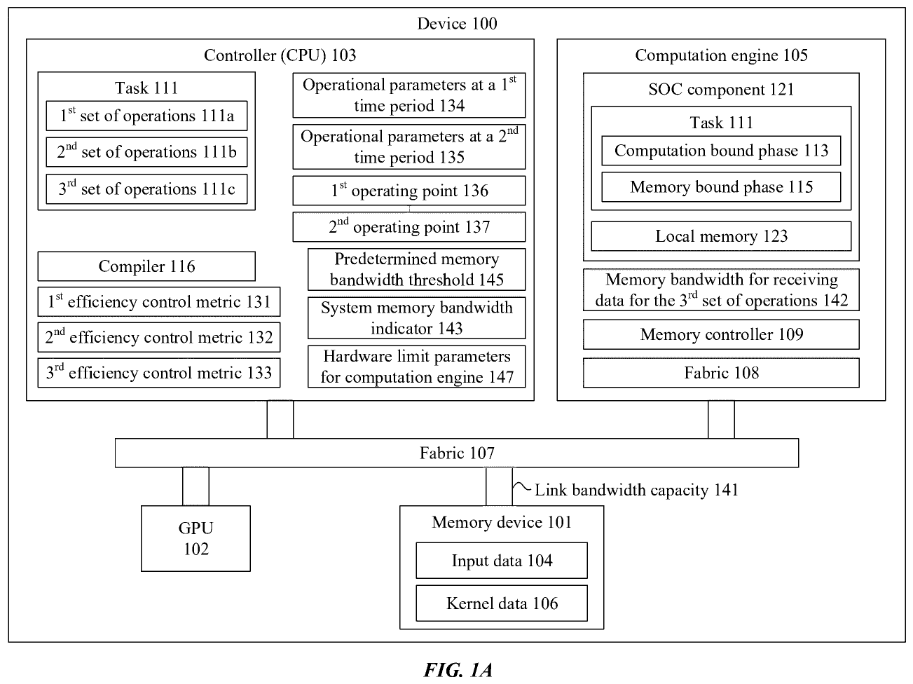

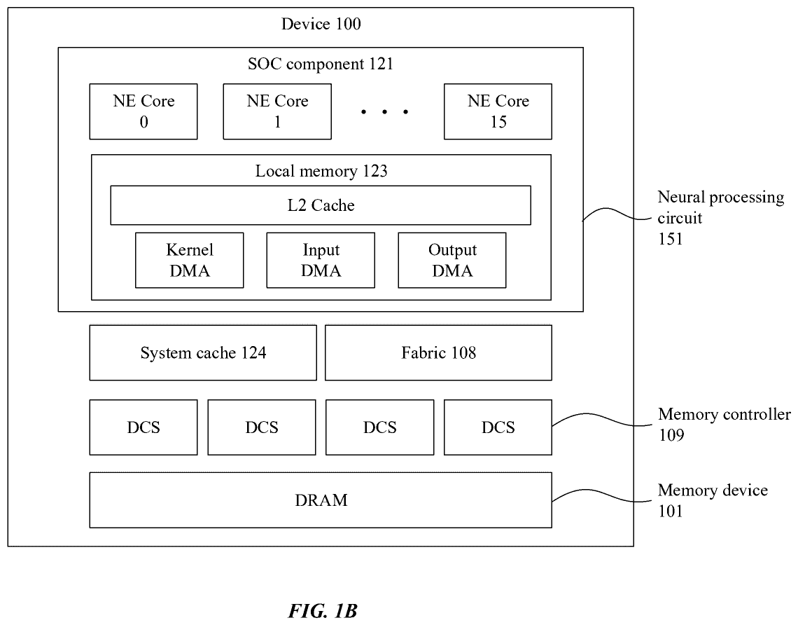

FIGS. 1A-1B are illustrations of a device 100 including a computation engine 105 for execution of a task 111 having computation bound and memory bound phases, according to some embodiments.

In some embodiments, device 100 can include a memory device 101 storing data for the computation of task 111, a controller 103 to control the operation of task 111, and a computation engine 105 to perform the computation of task 111. In some embodiments, data stored in memory device 101 can include input data 104 and kernel data 106. In some embodiments, kernel data 106 can include multiple weights. In some embodiments, controller 103 may be an entity operated by a central processing unit (CPU) or an entity operated in coordination with the CPU. Computation engine 105 can include a system-on-chip (SOC) component 121. Memory device 101, controller 103, and computation engine 105 can be communicatively coupled by a communication fabric 107. In some embodiments, device 100 can include an additional component, such as a graphics processing unit (GPU) 102.

In some embodiments, the operations of task 111 can be divided into a computation bound phase 113 or a memory bound phase 115. In some embodiments, operations performed during computation bound phase 113 can be performed by computation engine 105, SoC component 121, or other related hardware components. Operations performed during computation bound phase 113 can include other operations, such as access to memory 101 or other storage device local to computation engine 105. In some embodiments, operations performed by computation engine 105 or SoC component 121 can be a significant portion (e.g., 80% or 90%) of the operations during computation bound phase 113.

In some embodiments, operations performed during memory bound phase 115 can access memory 101 through fabric 107. Operations performed during memory bound phase 115 can include other operations, such as operations performed by computation engine 105. In some embodiments, operations performed for accessing memory 101 can be a significant portion (e.g., 80% or 90%) of the operations during memory bound phase 115. In some embodiments, memory bound phase 115 and computation bound phase 113 can be defined, identified, indicated, or hinted by a compiler 116. In some embodiments, the compiler 116 can provide first order heuristics that can be used to drive the controller's decisions at runtime whether a computation is in memory bound phase 115 or computation bound phase 113.

In some embodiments, controller 103 can be configured to identify computation bound phase 113 or memory bound phase 115 of task 111. In some embodiments, computation bound phase 113 and memory bound phase 115 can be mutually exclusive phases of operations for task 111. The execution of task 111 can be in either computation bound phase 113 or memory bound phase 115. Controller 103 can determine an efficiency control metric that scales with available system bandwidth and adaptively control computation engine 105 to an efficient operating point to achieve desired power performance tradeoffs. In some embodiments, an operating point of computation engine 105 can indicate an operation frequency or a supply voltage for computation engine 105. When computation engine 105 operates at a higher frequency or voltage at one time instance than that at another time instance, computation engine 105 can consume more power at the one time instance. Accordingly, it is expected that computation engine 105 can perform more operations when computation engine 105 operates at a higher frequency or voltage. On the other hand, when computation engine 105 performs fewer operations at the one time instance, controller 103 can adaptively control computation engine 105 to operate at a lower frequency or voltage to save power.

In some embodiments, task 111 can be characterized by different workloads and performance metrics. Tasks can be categorized along two independent axes or parameters: by a quality of service (QOS) axis and by submitting a thread group of the task (e.g., a thread group can be viewed as an application or a group of threads working towards achieving a common purpose for applications). A task can be classified into three different categories based on the QoS requirements. A background QoS job or task can focus on energy efficiency without any performance considerations by running at the lowest frequency. A utility QoS job or task can limit the impact of jobs that don't have high user visibility (e.g., background photo processing task by an application that is not visible to the user) by subjecting the job to a frequency cap or limitation. In addition, a higher QoS task or job doesn't have special performance considerations, but may have different priority considerations (e.g., a user initiated QoS job can run first at a higher priority before a default QoS job). On the other hand, based on the thread group axis, a task or a job can be classified into two categories. Jobs submitted directly by a daemon thread group that does not perform work on behalf of the foreground application that can run in the most energy efficient manner regardless of the QoS (e.g., this category includes all jobs submitted by daemons directly that are not on behalf of any application considered background). In addition, jobs submitted by non-daemon (e.g., normal) thread groups are allowed access to the full performance range subject to the QoS of the submitted job. In some embodiments, task 111 controlled by controller 103 can primarily operate on jobs submitted by normal thread groups with a default QoS or higher to achieve power/performance tradeoffs that cannot be accomplished by annotating jobs or inferring performance requirements based on the submitting thread group.

In some embodiments, task 111 can be a task based on a large language model (LLM). Task 111 can be autoregressive “document completers” that consume a stream of input tokens and predict a set of output tokens. An LLM can have billions of parameters (weights) to be loaded in order to perform an inference; so they can be bottlenecked by memory bandwidth on, for example, mobile platforms. LLM related task 111, such as LLM inference, can have 2 distinct execution phases: (1) compute bound phase 113 that processes input tokens in parallel to generate the first output token, and (2) memory bound phase 115 that outputs new tokens one at a time given all previously-generated tokens. During compute bound phase 113, all the input tokens can be processed and the first output token can be generated. Performance in compute bound phase 113 can be measured by a time to first token (TTFT). Since input tokens can be processed in parallel, for a sufficiently large input, compute bound phase 113 can compute bound and scales with computation engine 105 frequency (subject to physical device constraints like temperature, etc.). During memory bound phase 115, the intermediate state from processing the input prompt a previously generated tokens are used to predict the next output token. Performance in memory bound phase 115 can be measured by the token rate (e.g., tokens/second) for tokens being generated. Since the token generation process can be autoregressive, memory bound phase 115 can be memory bound and shows minimal performance improvement beyond the DRAM bandwidth saturating computation engine 105 frequency. The durations of compute bound phase 113 and memory bound phase 115 can be a function of the workload for task 111. For example, a summarization task might have a longer compute bound phase 113 than other non-summarization related tasks since it involves revising an input prompt, whereas a professional tone rewrite task may have a longer memory bound phase 115 since it involves generating a large number of tokens.

Controller 103 can identify compute bound phase 113 and memory bound phase 115 for LLM-based task 111. In addition, controller 103 can dynamically adjust at runtime the operating point, such as the operation frequency or supply voltage of computation engine 105, based on whether LLM-based task 111 is in compute bound phase 113 or memory bound phase 115 and further in response to available system resources to achieve the desired power performance tradeoffs.

In some embodiments, task 111 can include a first set of operations 111a, a second set of operations 111b, and a third set of operations 111c. Computation engine can perform the first set of operations 111a during a first time period, perform the second set of operations 111b during a second time period, and perform the third set of operations 111c during a third time period. Memory device 101 can be configured to store data for task 111 including the first set of operations 111a, the second set of operations 111b, and the third set of operations 111c. Controller 103 can be configured to determine a first efficiency control metric 131 of the first set of operations 111a based on one or more operational parameters 134 in the first time period, or determine a second efficiency control metric 132 of the second set of operations 111b based on one or more operational parameters 135 in the second time period. Furthermore, controller 103 can determine, based on the first efficiency control metric 131, that the first set of operations 111a is associated with computation bound phase 113 of task 111. In addition, controller 103 can determine, based on the second efficiency control metric 132, that the second set of operations 111b is associated with memory bound phase 115 of task 111. Controller 103 can determine a first operating point 136 and a second operating point 137 of computation engine 105, where computation engine 105 is configured to perform the first set of operations 111a under the first operating point 136 during the first time period and perform the second set of operations 111b under the second operating point 137 during the second time period.

In some embodiments, computation engine 105 can consume a first power in response to being operated under the first operating point 136 to perform the first set of operations 111a of computation bound phase 113, and consume a second power in response to being operated under the second operating point 137 to perform the second set of operations 111b of memory bound phase 115, where the first power is larger than the second power. Accordingly, computation engine 105 can be adjusted to consume less power during memory bound phase 115.

In some embodiments, computation engine 105 can include a communication fabric 108, a memory controller 109, a local memory 123, and neural engine circuits configured to perform the operations of task 111. In some embodiments, communication fabric 108 can be coupled or be a part of communication fabric 107.

FIG. 1B shows hardware components involved in a task (e.g., an LLM inference) on a mobile SOC (e.g., SOC component 121), according to some embodiments. SoC component 121 can include a neural processing circuit 151, which can also be referred to herein as a neural engine (NE). The NE can be the primary compute element including several neural engine (NE) cores, e.g., NE core 0, NE core 1, . . . , NE core 15, that perform math operations. In addition, the neural engine can include a level 2 (L2) cache that can be a scratch pad memory for all the NE cores and DMA engines for reading/writing data from memory 101 that can be a dynamic random access memory (DRAM). Accordingly, L2 cache can be an example of local memory 123. In some embodiments, a system cache 124 can be located between the neural engine cores and memory device 101, e.g., DRAM. In some embodiments, system cache 124, which can also be a part of local memory 123, can be faster to access and is shared by all agents on the SoC. A system bus (e.g., fabric 108 and/or fabric 107) connects the neural engine and system cache 124 to memory device 101 (DRAM) via several instances of DRAM Control Subsystem (DCS), which are examples of memory controller 109. All the components involved in computation node (e.g., NE, fabric, and DCS) can have a discrete set of operating points as defined by their respective dynamic voltage and frequency management (DVFM) tables, where an operating point can be defined by a frequency, a voltage, or any other performance metrics.

In some embodiments, controller 103 can determine the first efficiency control metric 131 of the first set of operations 111a based on one or more operational parameters 134 in the first time period, and determine the second efficiency control metric 132 of the second set of operations 111b based on one or more operational parameters 135 in the second time period. In some embodiments, the first time period can be equal to the second time period. In some embodiments, controller 103 can periodically determine an efficiency control metric of a set of operations of task 111. In some embodiments, at a third time period, controller 103 can determine a third efficiency control metric 133 of the third set of operations 111c of task 111.

In some embodiments, controller 103 can determine the third set of operations 111c is associated with the computation bound phase or with the memory bound phase based on a predetermined memory bandwidth threshold 145 and a system memory bandwidth indicator 143. The system memory bandwidth indicator 143 can be based on a ratio of a memory bandwidth 142 used to receive data stored in memory device 101 for the third set of operations 111c to a link bandwidth capacity 141 between computation engine 105 and memory device 101. In some embodiments, link bandwidth capacity 141 can be the maximum bandwidth between computation engine 105 and memory device 101. In some embodiments, not all of link bandwidth capacity 141 is used for receiving data stored in memory device 101 for the third set of operations 111c. Hence, system memory bandwidth indicator 143 can be used to indicate how busy the link between computation engine 105 and memory device 101 is used for receiving data stored in memory device 101 for the third set of operations 111c. In some embodiments, the memory bandwidth 142 used to receive the data stored in memory device 101 for the third set of operations 111c can be determined based on a number of bits in one or more weights used for the third set of operations 111c.

In some embodiments, predetermined memory bandwidth threshold 145 can have a first value of 50%. Controller 103 can determine the third set of operations 111c is associated with the computation bound phase 113 in response to the memory bandwidth 142 used to receive the data stored in memory device 101 for the third set of operations 111c being below the first value in comparison with link bandwidth capacity 141. As indicated, memory bandwidth 142 used to receive the data stored in memory device 101 for the third set of operations 111c is less than 50% of the link bandwidth capacity 141. Accordingly, controller 103 can determine the third set of operations 111c is associated with the computation bound phase because there is plenty of link bandwidth capacity not used for the link between memory device 101 and computation engine 105.

In some embodiments, predetermined memory bandwidth threshold 145 can have a second value of 90%. Controller 103 can determine the third set of operations 111c is associated with the memory bound phase 115 in response to the memory bandwidth 142 used to receive the data stored in memory device 101 for the third set of operations 111c being above the second value in comparison with link bandwidth capacity 141. As indicated, memory bandwidth 142 used to receive the data stored in memory device 101 for the third set of operations 111c is more than 90% of the link bandwidth capacity 141. Accordingly, controller 103 can determine the third set of operations 111c is associated with the memory bound phase because over 90% of the link bandwidth capacity is used for the third set of operations 111c for the communication over the link between memory device 101 and computation engine 105.

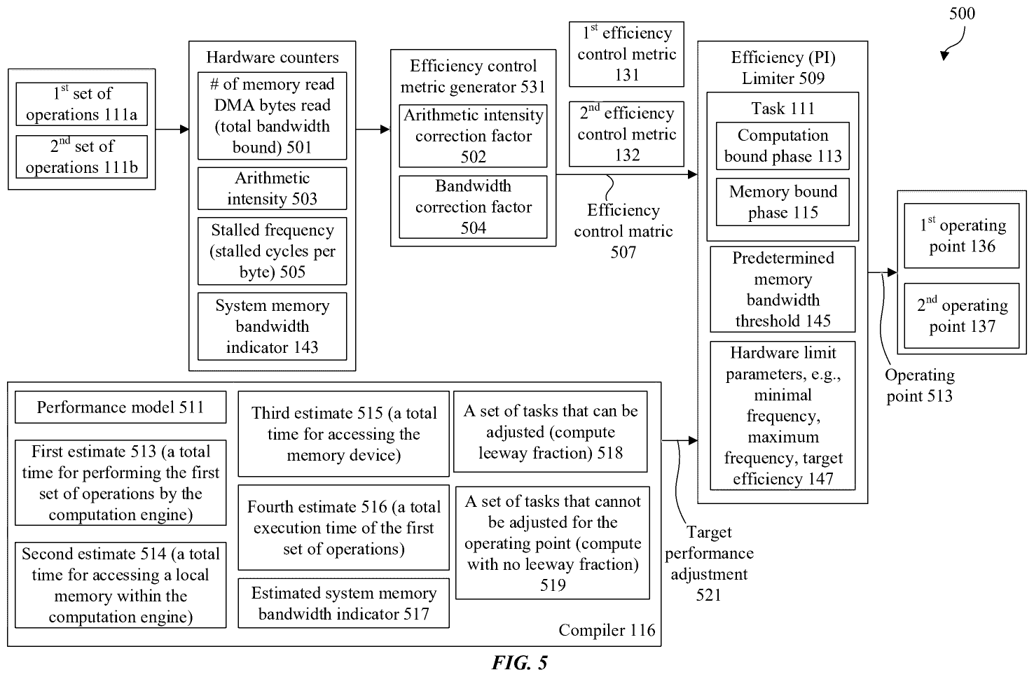

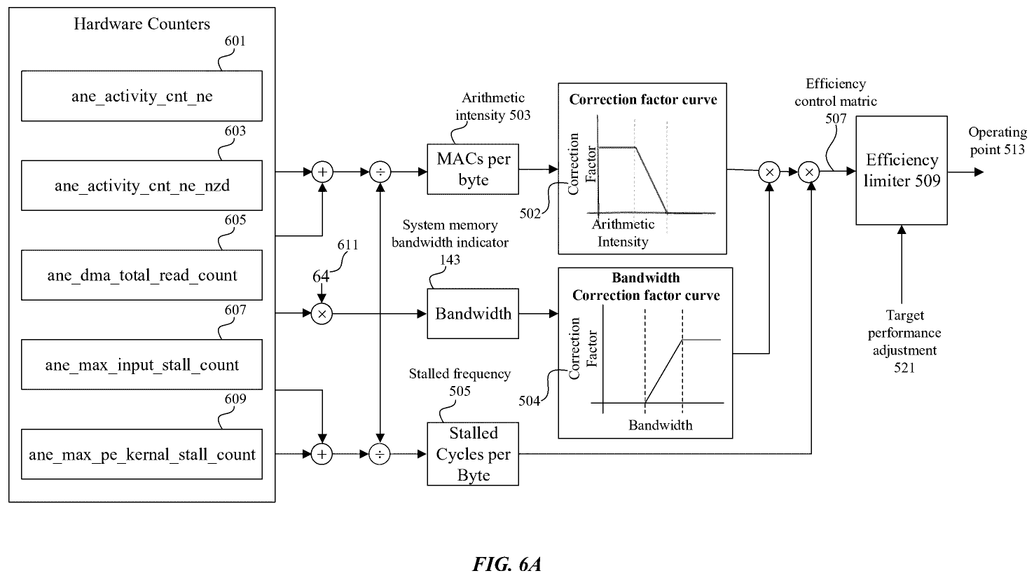

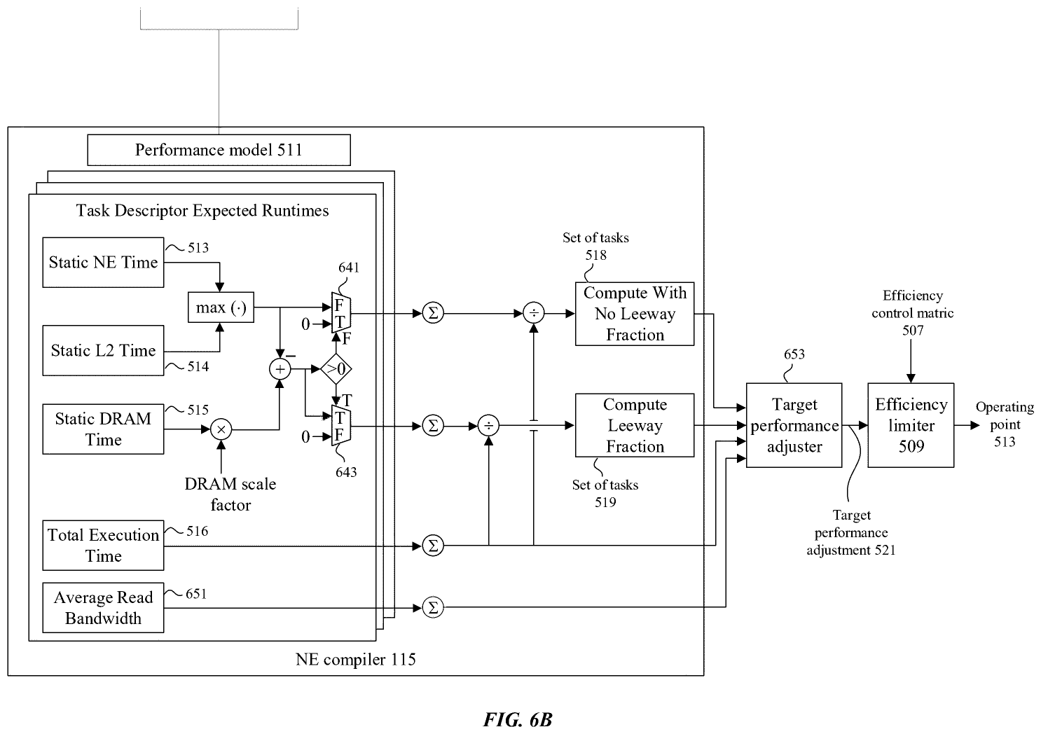

In some embodiments, controller 103 can determine an efficiency control metric of a set of operations during a time period, such as the first efficiency control metric 131, the second efficiency control metric 132, the third efficiency control metric 133, based on an arithmetic intensity indicating a number of operations performed by the computation engine during the time period for the set of operations, a stall frequency indicating a number of stalls for the computation engine to wait for data including input data and kernel data from the memory device during the time period for the set of operations, a system memory bandwidth indicator during the time period for the set of operations, or a number of memory read count during the time period to read data for the task from the memory device configured to store the data for the task. More details of such operations are illustrated in FIGS. 5 and 6A-6B, according to some embodiments.

In some embodiments, controller 103 can determine the first operating point 136 and the second operating point 137 of computation engine 105 based on one or more hardware limit parameters 147 for computation engine 105. More details of one or more hardware limit parameters 147 can be illustrated in FIGS. 5 and 6A-6B, according to some embodiments.

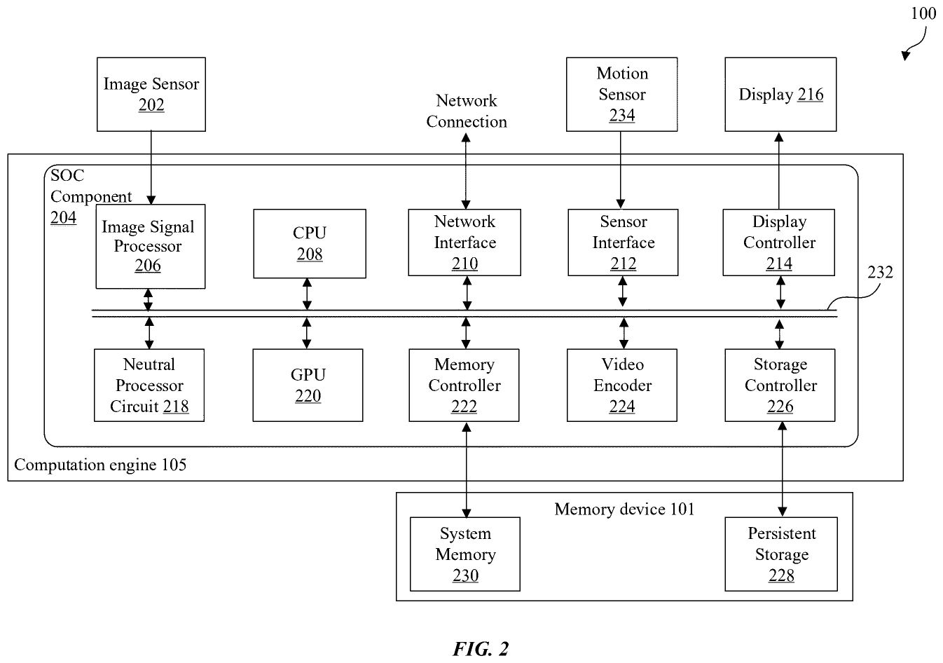

FIG. 2 is a block diagram illustrating components in device 100, according to some embodiments. Device 100 may perform various operations including implementing one or more machine learning models. For this and other purposes, device 100 may include image sensors 202, a system-on-a chip (SOC) component 204 included in computation engine 105, a system memory 230, a persistent storage (e.g., flash memory) 228, a motion sensor 234, and a display 216. In some embodiments, controller 103, fabric 107, and GPU 102 may be integrated into SOC component 204 as well. The components in FIG. 2 are merely illustrative. For example, device 100 may include other components (e.g., speaker or microphone) that are not illustrated in FIG. 2. Further, some components (such as motion sensor 234) may be omitted from device 100.

An image sensor 202 is a component for capturing image data and may be embodied, for example, as a complementary metal-oxide-semiconductor (CMOS) active-pixel sensor) a camera, video camera, or other devices. Image sensor 202 generates raw image data that is sent to SOC component 204 for further processing. In some embodiments, the image data processed by SOC component 204 is displayed on display 216, stored in system memory 230, persistent storage 228 or sent to a remote computing device via network connection. The raw image data generated by image sensor 202 may be in a Bayer color kernel array (CFA) pattern.

Motion sensor 234 is a component or a set of components for sensing motion of device 100. Motion sensor 234 may generate sensor signals indicative of orientation and/or acceleration of device 100. The sensor signals are sent to SOC component 204 for various operations such as turning on device 100 or rotating images displayed on display 216.

Display 216 is a component for displaying images as generated by SOC component 204. Display 216 may include, for example, liquid crystal display (LCD) device or an organic light-emitting diode (OLED) device. Based on data received from SOC component 204, display 216 may display various images, such as menus, selected operating parameters, images captured by image sensor 202 and processed by SOC component 204, and/or other information received from a user interface of device 100 (not shown).

System memory 230 is a component for storing instructions for execution by SOC component 204 and for storing data processed by SOC component 204. System memory 230 may be embodied as any type of memory including, for example, dynamic random access memory (DRAM), synchronous DRAM (SDRAM), double data rate (DDR, DDR2, DDR3, etc.) RAMBUS DRAM (RDRAM), static RAM (SRAM), or a combination thereof. In some embodiments, system memory 230 and/or persistent storage 228 can be examples of memory device 101.

Persistent storage 228 is a component for storing data in a non-volatile manner. Persistent storage 228 retains data even when power is not available. Persistent storage 228 may be embodied as read-only memory (ROM), flash memory or other non-volatile random access memory devices. Persistent storage 228 stores an operating system of device 100 and various software applications. Persistent storage 228 may also store one or more machine learning models, such as regression models, random forest models, support vector machines (SVMs) such as kernel SVMs, and artificial neural networks (ANNs) such as convolutional network networks (CNNs), recurrent network networks (RNNs), autoencoders, and long short term memory (LSTM). A machine learning model may be an independent model that works with the neural processor circuit 218 and various software applications or sensors of device 100. A machine learning model may also be part of a software application. The machine learning models may perform various tasks such as facial recognition, image classification, object, concept, and information classification, speech recognition, machine translation, voice recognition, voice command recognition, text recognition, text and context analysis, other natural language processing, predictions, and recommendations.

Various machine learning models stored in device 100 may be fully trained, untrained, or partially trained to allow device 100 to reinforce or continue to train the machine learning models as device 100 is used. Operations of the machine learning models include various computation used in training the models and determining results in runtime using the models. For example, in one case, device 100 captures facial images of the user and uses the images to continue to improve a machine learning model that is used to lock or unlock the device 100.

SOC component 204 is embodied as one or more integrated circuit (IC) chip and performs various data processing processes. SOC component 204 may include, among other subcomponents, image signal processor (ISP) 206, a central processor unit (CPU) 208, a network interface 210, sensor interface 212, display controller 214, neural processor circuit 218, graphics processor (GPU) 220, memory controller 222, video encoder 224, storage controller 226, and bus 232 connecting these subcomponents. SOC component 204 may include more or fewer subcomponents than those shown in FIG. 2.

ISP 206 is a circuit that performs various stages of an image processing pipeline. In some embodiments, ISP 206 may receive raw image data from image sensor 202, and process the raw image data into a form that is usable by other subcomponents of SOC component 204 or components of device 100. ISP 206 may perform various image-manipulation operations, such as image translation operations, horizontal and vertical scaling, color space conversion and/or image stabilization transformations.

CPU 208 may be embodied using any suitable instruction set architecture and may be configured to execute instructions defined in that instruction set architecture. CPU 208 may be general-purpose or embedded processors using any of a variety of instruction set architectures (ISAs), such as the x86, PowerPC, SPARC, RISC, ARM or MIPS ISAs, or any other suitable ISA. Although a single CPU is illustrated in FIG. 2, SOC component 204 may include multiple CPUs. In multiprocessor systems, each of the CPUs may, but not necessarily, implement the same ISA.

Graphics processing unit (GPU) 220 is graphics processing circuitry for performing graphical data. For example, GPU 220 may render objects to be displayed into a frame buffer (e.g., one that includes pixel data for an entire frame). GPU 220 may include one or more graphics processors that may execute graphics software to perform a part or all of the graphics operation, or hardware acceleration of certain graphics operations.

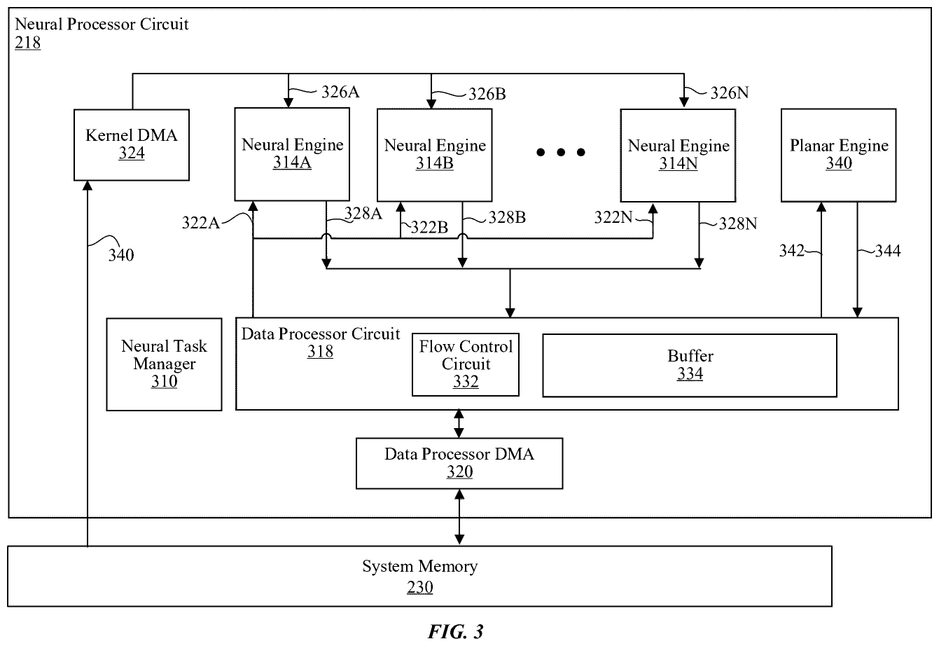

Neural processor circuit 218 is a circuit that performs various machine learning operations based on computation including multiplication, addition, and accumulation. Such computation may be arranged to perform, for example, various types of tensor multiplications such as tensor product and convolution of input data and kernel data. Neural processor circuit 218 is a configurable circuit that performs these operations in a fast and power-efficient manner while relieving CPU 208 of resource-intensive operations associated with neural network operations. Neural processor circuit 218 may receive the input data from sensor interface 212, image signal processor 206, persistent storage 228, system memory 230, or other sources such as network interface 210 and GPU 220. The output of neural processor circuit 218 may be provided to various components of device 100, such as image signal processor 206, system memory 230, and CPU 208, for various operations. The structure and operation of neural processor circuit 218 are described below in detail with reference to FIG. 3.

Network interface 210 is a subcomponent that enables data to be exchanged between devices 100 and other devices via one or more networks (e.g., carrier or agent devices). For example, video or other image data may be received from other devices via network interface 210 and be stored in system memory 230 for subsequent processing (e.g., via a back-end interface to image signal processor 206) and display. The networks may include, but are not limited to, Local Area Networks (LANs) (e.g., an Ethernet or corporate network) and Wide Area Networks (WANs). The image data received via network interface 210 may undergo image processing processes by ISP 206.

Sensor interface 212 is circuitry for interfacing with motion sensor 234. Sensor interface 212 receives sensor information from motion sensor 234 and processes the sensor information to determine the orientation or movement of device 100.

Display controller 214 is circuitry for sending image data to be displayed on display 216. Display controller 214 receives the image data from ISP 206, CPU 208, graphic processor or system memory 230 and processes the image data into a format suitable for display on display 216.

Memory controller 222 is circuitry for communicating with system memory 230. Memory controller 222 may read data from system memory 230 for processing by ISP 206, CPU 208, GPU 220 or other subcomponents of SOC component 204. Memory controller 222 may also write data to system memory 230 received from various subcomponents of SOC component 204.

Video encoder 224 is hardware, software, firmware or a combination thereof for encoding video data into a format suitable for storing in persistent storage 228 or for passing the data to network interface 210 for transmission over a network to another device.

In some embodiments, one or more subcomponents of SOC component 204 or some functionality of these subcomponents may be performed by software components executed on neural processor circuit 218, ISP 206, CPU 208, or GPU 220. Such software components may be stored in system memory 230, persistent storage 228, or another device communicating with device 100 via network interface 210.

Neural processor circuit 218 is a programmable circuit that performs machine learning operations on the input data of neural processor circuit 218, according to some embodiments. Machine learning operations may include different computations for training of a machine learning model and for performing inference or prediction based on the trained machine learning model.

Taking an example of a CNN as the machine learning model, training of the CNN may include forward propagation and backpropagation. A neural network may include an input layer, an output layer, and one or more intermediate layers that may be referred to as “hidden layers.” Each layer may include one or more nodes, which may be fully or partially connected to other nodes in adjacent layers. In forward propagation, the neural network performs computation in the forward direction based on outputs of a preceding layer. The operations of a node may be defined by one or more functions. The functions that define the operation of a node may include various computation operations, such as convolution of data with one or more kernels, pooling of layers, and tensor multiplication. The functions may also include an activation function that adjusts the weight of the output of the node. Nodes in different layers may be associated with different functions. For example, a CNN may include one or more convolutional layers that are mixed with pooling layers and are followed by one or more fully connected layers.

Each of the functions, including kernels, in a machine learning model may be associated with different coefficients that are adjustable during training. In addition, some of the nodes in a neural network each may also be associated with an activation function that decides the weight of the output of the node in a forward propagation. Activation functions may include step functions, linear functions, sigmoid functions, hyperbolic tangent functions (tanh), and rectified linear unit functions (ReLU). After a batch of data of training samples passes through a neural network in the forward propagation, the results may be compared to the training labels of the training samples to compute the network's loss function, which represents the performance of the network. In turn, the neural network performs backpropagation by using coordinate descent such as stochastic coordinate descent (SGD) to adjust the coefficients in various functions to improve the value of the loss function.

In training, device 100 may use neural processor circuit 218 to perform all or some of the operations in the forward propagation and backpropagation. Multiple rounds of forward propagation and backpropagation may be performed by neural processor circuit 218, solely or in coordination with other processors, such as CPU 208, GPU 220, and ISP 206. Training may be completed when the loss function no longer improves (e.g., the machine learning model has converged) or after a predetermined number of rounds for a particular set of training samples. As device 100 is used, device 100 may continue to collect additional training samples for the neural network.

For prediction or inference, device 100 may receive one or more input samples. Neural processor circuit 218 may take the input samples to perform forward propagation to determine one or more results. The input samples may be images, speeches, text files, sensor data, or other data.

Data and functions (e.g., input data, kernels, functions, layers outputs, and gradient data) in machine learning may be saved and represented by one or more tensors. Operations related to training and runtime of a machine learning model may include tensor product, tensor transpose, tensor elementwise operation, convolution, application of an activation function, automatic differentiation to determine gradient, statistics and aggregation of values in tensors (e.g., average, variance, and standard deviation), tensor rank, and size manipulation.

While the training and runtime of a neural network are discussed as an example, the neural processor circuit 218 may also be used for the operations of other types of machine learning models, such as a kernel SVM.

Referring to FIG. 3, neural processor circuit 218 may include a neural task manager 310, neural engines 314A through 314N (hereinafter collectively referred as “neural engines 314” and individually also referred to as “neural engine 314”), a kernel direct memory access (DMA) 324, a data processor circuit 318, a data processor DMA 320, and a planar engine 340. Neural processor circuit 218 may include fewer or additional components not illustrated in FIG. 3.

Each of neural engines 314 performs computing operations for machine learning in parallel. Depending on the load of operation, the entire set of neural engines 314 may be operating or only a subset of the neural engines 314 may be operating while the remaining neural engines 314 are placed in a power-saving mode to conserve power. Each of neural engines 314 includes components for storing one or more kernels, for performing multiply-accumulate operations, and for post-processing to generate an output data 328. Neural engines 314 may specialize in performing computationally-heavy operations, such as convolution operations and tensor product operations. Convolution operations may include different kinds of convolutions, such as cross-channel convolutions (e.g., a convolution that accumulates values from different channels), channel-wise convolutions, and transposed convolutions.

Planar engine 340 may specialize in performing simpler computing operations whose speed may primarily depend on the input and output (I/O) speed of the data transmission instead of the computation speed within planar engine 340. Those computing operations may be referred to as “I/O bound computations.” In contrast, neural engines 314 may focus on complex computations whose speed may primarily depend on the computation speed within each neural engine 314. For example, planar engine 340 is efficient at performing operations within a single channel, while neural engines 314 are efficient at performing operations across multiple channels that may involve heavy accumulation of data. The use of neural engine 314 to compute I/O bound computations may not be efficient in terms of both speed and power consumption. In some embodiments, input data may be a tensor whose rank is larger than three (e.g., having three or more dimensions). A set of dimensions (two or more) in the tensor may be referred to as a “plane,” while another dimension may be referred to as a “channel.” Neural engines 314 may convolve data of a plane in the tensor with a kernel and accumulate results of the convolution of different planes across different channels. On the other hand, planar engine 340 may specialize in operations within the plane.

The circuitry of planar engine 340 may be programmed for operation in one of multiple modes, including a pooling mode, an elementwise mode, and a reduction mode. In the pooling mode, planar engine 340 reduce a spatial size of input data. In the elementwise mode, planar engine 340 generates an output that is derived from elementwise operations of one or more inputs. In the reduction mode, planar engine 340 reduces the rank of a tensor. For example, a rank 5 tensor may be reduced to a rank 2 tensor, or a rank 3 tensor may be reduced to a rank 0 tensor (e.g., a scalar).

Neural task manager 310 manages the overall operation of neural processor circuit 218. Neural task manager 310 may receive a task list from a compiler executed by CPU 208, store tasks in its task queues, choose a task to perform, and send task commands to other components of the neural processor circuit 218 for performing the chosen task. Data may be associated with a task command that indicates the types of operations to be performed on the data. Data of neural processor circuit 218 includes input data that is transmitted from another source, such as system memory 230, and data generated by the neural processor circuit 218 in a previous operation cycle. Each dataset may be associated with a task command that specifies the type of operations to be performed on the data. Neural task manager 310 may also perform switching of tasks on detection of events, such as receiving instructions from CPU 208. In some embodiments, neural task manager 310 sends rasterizer information to the components of neural processor circuit 218 to enable each of the components to track, retrieve or process appropriate segments of the input data and kernel data. For example, neural task manager 310 may include registers that stores the information regarding the size and rank of a dataset for processing by the neural processor circuit 218. Although neural task manager 310 is illustrated in FIG. 3 as part of neural processor circuit 218, neural task manager 310 may be a component outside the neural processor circuit 218.

Kernel DMA 324 is a read circuit that fetches kernel data from a source (e.g., system memory 230) and sends kernel data 326A through 326N to each of neural engines 314. Kernel data represents information from which kernel elements can be extracted. In some embodiments, the kernel data may be in a compressed format, which is decompressed at each of neural engines 314. Although kernel data provided to each of neural engines 314 may be the same in some instances, the kernel data provided to each of neural engines 314 is different in most instances. In some embodiments, the direct memory access nature of kernel DMA 324 may allow kernel DMA 324 to fetch and write data directly from the source without the involvement of CPU 208.

Data processor circuit 318 manages data traffic and task performance of neural processor circuit 218. Data processor circuit 318 may include a flow control circuit 332 and a buffer 334. Buffer 334 is temporary storage for storing data associated with operations of neural processor circuit 218 and planar engine 340, such as input data that is transmitted from system memory 230 (e.g., data from a machine learning model) and other data that is generated within neural processor circuit 218 or planar engine 340. The data stored in data processor circuit 318 may include different subsets that are sent to various downstream components, such as neural engines 314 and planar engine 340.

In some embodiments, buffer 334 is embodied as a non-transitory memory that can be accessed by neural engines 314 and planar engine 340. Buffer 334 may store input data 322A through 322N for feeding to corresponding neural engines 314A through 314N or planar engine 340, as well as output data 328A through 328N from each of neural engines 314A through 314N or planar engine 340 for feeding back into one or more neural engines 314 or planar engine 340, or sending to a target circuit (e.g., system memory 230). Buffer 334 may also store input data 342 and output data 344 of planar engine 340 and allow the exchange of data between neural engine 314 and planar engine 340. For example, one or more output data 328A through 328N of neural engines 314 are used as the input 342 to planar engine 340. Likewise, the output 344 of planar engine 340 may be used as the input data 322A through 322N of neural engines 314. The inputs of neural engines 314 or planar engine 340 may be any data stored in buffer 334. For example, in various operating cycles, the source datasets from which one of the engines fetches as inputs may be different. The input of an engine may be an output of the same engine in previous cycles, outputs of different engines, or any other suitable source datasets stored in buffer 334. Also, a dataset in buffer 334 may be divided and sent to different engines for different operations in the next operating cycle. Two datasets in buffer 334 may also be joined for the next operation.

Flow control circuit 332 of data processor circuit 318 may control the exchange of data between neural engines 314 and planar engine 340. The operations of data processor circuit 318 and other components of neural processor circuit 218 are coordinated so that the input data and intermediate data stored in data processor circuit 318 may be reused across multiple operations at neural engines 314 and planar engine 340, thereby reducing data transfer to and from system memory 230. Flow control circuit 332 may perform one or more of the following operations: (i) monitor the size and rank of data (e.g., data may be one or more tensors) that are being processed by neural engines 314 and planar engine 340, (ii) determine which subsets of data are transmitted to neural engines 314 or to planar engine 340 based on the task commands associated with different subsets of data, (iii) determine the manner in which data is transmitted to neural engines 314 and planar engine 340 (e.g., the data processor circuit 318 may operate in a broadcast mode where the same data is fed to multiple input channels of neural engines 314 so that multiple or all neural engines 314 receive the same data or in a unicast mode where different neural engines 314 receives different data), and (iv) transmit a configuration command to the planar engine 340 to direct planar engine 340 to program itself for operating in one of multiple operation modes.

The data of neural processor circuit 218 stored in buffer 334 may be part of, among others, image data, histogram of oriented gradients (HOG) data, audio data, metadata, output data 328 of a previous cycle of a neural engine 314, and other processed data received from other components of the SOC component 204.

Data processor DMA 320 includes a read circuit that receives a segment of the input data from a source (e.g., system memory 230) for storing in buffer 334, and a write circuit that forwards data from buffer 334 to a target component (e.g., system memory). In some embodiments, the direct memory access nature of data processor DMA 320 may allow data processor DMA 320 to fetch and write data directly from a source (e.g., system memory 230) without the involvement of CPU 208. Buffer 334 may be a direct memory access buffer that stores data of a machine learning model of device 100 without involvement of CPU 208.

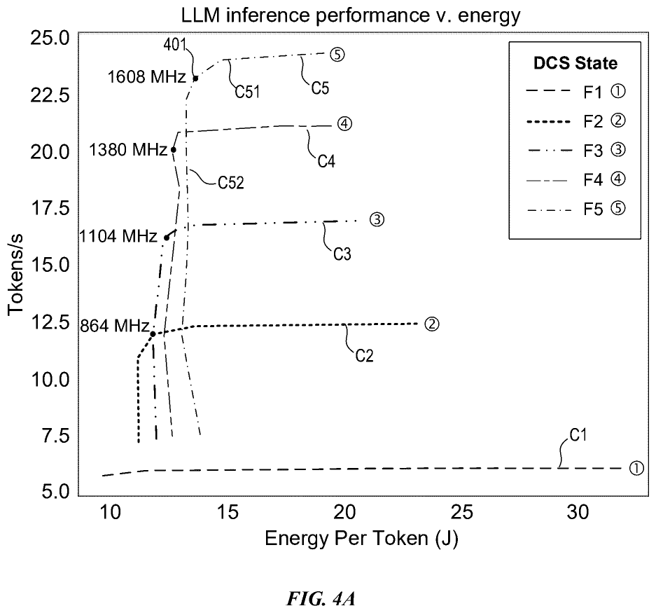

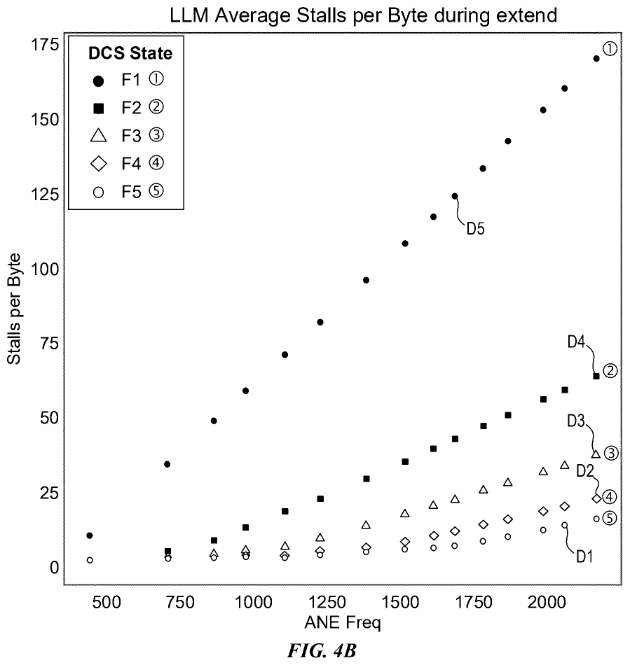

FIGS. 4A-4B are illustrations of relationships between the performance and power consumptions for the execution of the task, according to some embodiments. In some embodiments, the curves C1, C2, C3, C4, and C5 as shown in FIG. 4A and the curves D1, D2, D3, D4, and D5 as shown in FIG. 4B show a relationship between performance and energy at different memory speeds and NE frequencies for the execution of task 111.

In some embodiments, as shown in FIG. 4A, each curve is generated by fixing the memory state (or peak bandwidth) and sweeping through the different ANE frequencies. Each of the curves C1, C2, C3, C4, and C5 represents a different memory bandwidth configuration (F1, F2, F3, F4 and F5 respectively). The lower the memory bandwidth, the slower the ANE needs to run to saturate memory bandwidth. Accordingly, curve C5 represents the energy consumption per token for a LLM task related to a token rate for tokens being generated at an operating point F5 (e.g., 51.2 GB/s). Accordingly, the 1608 MHz number is the minimum frequency at which the ANE can run to saturate memory bandwidth when memory state is F5. Curve C5 can include approximately two linear segments C51 and C52, which intersect at a point 401. The bandwidth saturating frequency is at the intersection of these 2 line segments. Curve C4 represents the energy consumption per token for the LLM task related to a token rate for tokens being generated at an operating point F4 (e.g., 43.7 GB/s). Each of the different clock frequency (e.g., 1608 MHz for C5, 1380 MHz for C4, 1104 MHz for C3, and 864 MHz for C2) is the corresponding memory bandwidth saturating operating point for SOC component 204 or SOC component 121. As shown by curves C1, C2, C3, C4, and C5, the speed of the token rate remains flat after the initial increase. Hence, after the speed of the token rate reaches to a particular point, such as point 401, increasing the energy for SOC component 204 or device 100 would not make a significant difference to the overall output produced by SOC component 204 or SOC component 121. Hence, point 401 would be an operating point with a desired power performance tradeoffs for task 111 at exemplary operating point 1608 MHz. In some embodiments, F1, F2, etc. are the different speeds at which memory can operate at (e.g., F5 is 51.2 GB/s). For each memory state, there's a bandwidth saturating frequency for the SoC component (e.g. 1608 MHz is the bandwidth saturating ANE frequency when memory is operating at the F5 memory state).

In some embodiments, as shown in FIG. 4B, the average stall per byte for memory access can be approximately linear for the different operating points D1, D2, D3, D4, and D5, with respect to the operating frequency. In some embodiments, a curve can be made of 2 linear segments with different slopes. The bandwidth saturating frequency is at the intersection of these 2 line segments. Accordingly, the higher frequency at which SOC component 204 or SOC component 121 operates, the more memory stall can happen.

FIG. 5 is a process 500 executed by controller 103 for controlling power performance tradeoffs for task 111 having computation bound and memory bound phases, according to some embodiments. In some embodiments, controller 103 can adjust the operating point of SOC component 121 or computation engine 105 in response to system behavior and power performance demands.

In some embodiments, controller 103 can annotate eligible assets or resources of device 100 in model catalog with an energy efficient indicator flag to indicate the assets or resources can be used for the computation of task 111. In some embodiments, the energy efficient indicator flag, or some other flag, can be used to indicate assets or computation resources that are eligible for energy efficient control controlled by controller 103. In some embodiments, assets can be models that run on the NE. In some embodiments, not all computing resources of device 100 can be used for computation of task 111. In some embodiments, controller 103 can forward the energy efficient indicator flag to computation engine 105 when task 111, e.g., an LLM inference, is active.

In some embodiments, an efficiency control metric generator 531 operated by controller 103 can combine DMA bytes read 501, arithmetic intensity 503, and stall frequency 505 into an efficiency control metric 507 that is scalable. In some embodiments, DMA bytes read 501 can be a number of memory reads and can represent a read bandwidth between controller 103 and memory 101. In some embodiments, controller 103 can feed efficiency control metric 507 through a proportional integral (PI) limiter 509 optionally using compiler performance model hints 511 generate by complier 116 to adjust the controller target. In some embodiments, compiler performance model hints 511 can be simply referred to as performance model 511, PI limiter 509 can also be referred to as efficiency limiter 509, and efficiency control metric 507 can be referred to as an efficiency metric. Accordingly, for the first set of operations 111a being performed at a first time period, efficiency control metric generator 531 can generate the first efficiency control metric 131. Similarly, for the second set of operations 111b being performed at a second time period, efficiency control metric generator 531 can generate the second efficiency control metric 132.

In some embodiments, arithmetic intensity 503 can measure how likely the execution of task 111 is in the computation bound phase, and stall frequency 505 can measure how likely the execution of task 111 is in the memory bound phase. In some embodiments, arithmetic intensity alone can distinguish between the compute and memory bounded phases. Stall frequency describes the degree of memory boundedness as well as the execution efficiency. Accordingly, a high stall frequency is a sign of inefficient execution. If the stalls are accompanied by high DRAM bandwidth, then this is an indication that the task is highly memory bound. Controller 103 can make a determination whether task 111 is in the computation bound phase or the memory bound phase based on efficiency control metric 507. PI limiter 509 can decide not to adjust the operating point 513 when the execution of task 111 is in the computation bound phase, since task 111 can use the power to perform the operations in computation bound phase. On the other hand, PI limiter 509 can decide to adjust the operating point 513 when the execution of task 111 is in the memory bound phase and the memory stall rate is high. In such a situation, when the memory stall rate is high in the memory bound phase of task 111, computation engine 105 can operate at a lower frequency or voltage without affecting the overall performance of task 111. In some embodiments, task 111 can be entirely running on the SoC component (e.g., SOC component 121 in computation engine 105). Controller 103 can signal the SoC component to operate at a particular frequency depending on the output of PI limiter 509. PI limiter 509 runs during both the memory and compute bound phases. A correction factor term, which is a part of the efficiency control metric construction described in FIG. 6A, can capture the memory/compute boundedness. The output of PI limiter 509 can be unconditionally used to decide how fast to run the NE (e.g., whether it should be allowed to run unconstrained or it should run slower so that it is more efficient).

In some embodiments, efficiency control metric generator 531 can be configured to determine the first efficiency control metric 131 of the first set of operations 111a based on (i) an arithmetic intensity 503 indicating a number of operations performed by computation engine 105 during the first time period for the first set of operations 111a, (ii) a stall frequency 505 indicating a number of stalls for computation engine 105 to wait for data including input data 104 and kernel data 106 from memory device 101 during the first time period for the first set of operations 111a, (iii) system memory bandwidth indicator 143 during the first time period for the first set of operations 111a, or (iv) a number of memory read count 501 during the first time period to read data for task 111 from the memory device 101 configured to store the data for task 111. The first efficiency control metric 131 can be determined based on one or more parameters described above.

In some embodiments, efficiency control metric generator 531 can be configured to determine the second efficiency control metric 132 of the second set of operations 111b based on (i) arithmetic intensity 503 indicating a number of operations performed by computation engine 105 during the second time period for the second set of operations 111b, (ii) stall frequency 505 indicating a number of stalls for computation engine 105 to wait for data including input data 104 and kernel data 106 from memory device 101 during the second time period for the second set of operations 111b, (iii) system memory bandwidth indicator 143 during the second time period for the second set of operations 111b, or (iv) a number of memory read count 501 during the second time period to read data from the memory device 101 configured to store the data. The second efficiency control metric 132 can be determined based on one or more parameters described above.

In some embodiments, efficiency control metric generator 531 can further determine the first efficiency control metric 131 of the first set of operations 111a based on an arithmetic intensity correction factor 502 and a bandwidth correction factor 504 being applied to stall frequency 505 for the first set of operations being performed at the first time period. In some embodiments, both arithmetic intensity correction factor 502 (which takes arithmetic intensity as input) and bandwidth correction factor 504 (which takes bandwidth as input) are combined multiplicatively and applied to stall frequency 505. In some embodiments, efficiency control metric generator 531 can further determine the second efficiency control metric 132 of the second set of operations 111b based on arithmetic intensity correction factor 502 and bandwidth correction factor 504 being applied to stall frequency 505 for the second set of operations 111b being performed at the second time period.

In some embodiments, efficiency limiter 509 can be further configured to determine the first operating point 136 and the second operating point 137 of computation engine 105 based on one or more hardware limit parameters 147 for computation engine 105. In some embodiments, efficiency limiter 509 can be configured to determine the first operating point 136 and the second operating point 137 of computation engine 105 based on predetermined memory bandwidth threshold 145.

In some embodiments, efficiency limiter 509 can further determine an operating point of computation engine 105 indicated by a target performance adjustment 521 generated by compiler 116 based on a task performance model 511 including tasks previously performed by computation engine 105.

In some embodiments, target performance adjustment 521 of the first set of operations 111a can be generated based on a first estimate 513 of a total time for performing the first set of operations 111a by computation engine 105, a second estimate 514 of a total time for accessing local memory 123 within computation engine 105 for performing the first set of operations 111a, a third estimate 515 of a total time for accessing memory device 101 for performing the first set of operations 111a, and a fourth estimate 516 of a total execution time of the first set of operations 111a, where the first estimate, the second estimate, the third estimate, and the fourth estimate are determined based on task performance model 511. In some embodiments, target performance adjustment 521 can be generated based on an estimated system memory bandwidth indicator 517 for the first set of operations 111a determined based on task performance model 511.

In some embodiments, target performance adjustment 521 can be generated based on a determination whether a task of the task performance model can be adjusted for an operating point of computation engine 105 based on a comparison of the third estimate 515 of the total time for accessing memory device 101 to the first estimate 513 of the total time for performing the first set of operations 111a by the computation engine, or based on a comparison of the third estimate 515 of the total time for accessing memory device 101 to the second estimate 514 of the total time for accessing local memory 123 within computation engine 105. A set of tasks 518 can be formed to include tasks that can be adjusted for the operating point (e.g., compute leeway fraction), and a set of tasks 519 can be formed to include tasks that cannot be adjusted for the operating point (e.g., compute with no leeway fraction).

FIGS. 6A-6B are systems for computing efficiency control metric 507 and target performance adjustment 521 for controlling power performance tradeoffs for a task having computation bound and memory bound phases, according to some embodiments. In some embodiments, FIG. 6A illustrates an example of how efficiency control metric 507 is calculated, and FIG. 6B illustrates an example of how target performance adjustment 521 for PI limiter 509 is determined.

Embodiments herein can identify the execution phases at runtime using a combination of hardware counters and compiler hints. Embodiments herein can determine the efficient operating point for tasks with varying degrees of compute and memory boundedness. In some embodiments, during the execution of task 111 at the computation bounded phase 113, task 111 can have a first efficient operating point. During the execution of task 111 at memory bounded phase 115, task 111 can have a second efficient operating point different from the first efficient operating point. In some embodiments, controller 103 can adapt to changing power/performance requirements either due to physical factors or product operating modes to find the new efficient operating point. In some embodiments, controller 103 can selectively bias towards performance or energy efficiency by annotating the QoS of the inference job or task 111 as well as inferring the performance requirements of the submitting application or task 111.

In some embodiments, efficiency control metric 507 can be generated based on various parameters to measure the performance of computation engine 105 and the memory access used for the computation. In some embodiments, a variable 601, ane_activity_cnt_ne, can represent the count of the total number of MAC operations across all NEs, where at least one input to the MAC operation is 0. In addition, a variable 603, ane_activity_cnt_ne_nzd, can represent the count of the total number of MAC operations across all NEs, where both inputs are non-zero. In some embodiments, the complexity of performing MAC operations with an input as 0 can be different from the complexity of performing MAC operations having no input as 0. In some embodiments, the two variables, variable 601 and variable 603, can be combined into one variable to count the total number of MAC operations, or other arithmetic operations of computation engine 105.

In some embodiments, a variable 605, ane_dma_total_read_count, counts input and kernel DMA access to memory device 101 in units of memory access, e.g., 64 bytes. Variable 605 can be an indication of the number of memory read 501. Variable 605 multiplied by a unit size 611, e.g., 64 bytes, can be the total memory access size. In some other embodiments, unit size 611 can be of a different size. A variable 607, ane_mac_input_stall_count, counts each cycle per NE where the NE cores are stalled waiting on input data. A variable 609, ane_mac_pe_kernel_stall_count, counts each cycle per NE where the NE cores are stalled waiting on kernel data. Parameters, such as variable 601, variable 603, variable 605, variable 607, and variable 609, are chosen as examples. In some other embodiments, there can be more parameters or less parameters used to generate efficiency control metric 507. In some embodiments, output stalls for storing the output generated by the NEs, or the delay for writing output data into memory device 101 can be included. In some embodiments related to LLMs, output stalls for storing the output generated by the NEs or the delay for writing output data can be ignored since the data access pattern of LLMs is dominated by reads. Hence, efficiency control metric 507 can be determined based on a set of parameters that can be an approximation of the real complete execution of task 111. In some embodiments, efficiency control metric 507 can scale with available system bandwidth and is capable of distinguishing between the prompt and extend phases of LLM tasks. The scalability of efficiency control metric 507 can allow controller 103 to be robust to model updates and situations where not all of the system bandwidth is available to the NE.

In some embodiments, arithmetic intensity 503 can be calculated as “MACs per Byte”, while stalled frequency 505 can be calculated as “Stalled Cycles per Byte,” as shown below, in addition to a variable Bandwidth:

$$MACs per Byte = \frac{ane\_activity \_cnt \_ne + ane\_activity \_cnt \_ne \_nzd}{ane\_dma \_total \_read \_count \times 64}$$

$$Stalled Cycles per Byte = \frac{ane\_mac \_input \_stall \_count + ane\_mac \_pe \_kernel \_stall \_count}{ane\_dma \_total \_read \_count \times 64}$$

$$Bandwidth = \frac{ane\_dma \_total \_read \_count \times 64}{sample\_time}$$

In some embodiments, MACs per Byte, as defined by the equation above, is an output variable for arithmetic intensity 503. MACs per Byte can be a bandwidth and frequency invariant property of a set of operations that is defined by the structure of the set of operations and can be a candidate metric to distinguish between the compute bound prompt phase (high arithmetic intensity) and the memory bound extend phase (low arithmetic intensity).

In some embodiments, Stalled Cycles per Byte can indicate an efficiency in its definition. If computation engine 105 experiences a high number of stalls for every byte of data read from memory device 101, such a high number of stalls can indicate that computation engine 105 may be running too fast for seemingly little benefit since a large number of cycles are spent stalling. Since computation engine 105 can include a very deeply pipelined machine, the latency of a single memory access is less relevant compared to the average bandwidth computation engine 105 can pull, which aligns well with the definition of the Stalled Cycles per Byte metric. In addition, Stalled Cycles per Byte metric can provide a limited ability to distinguish the source of the stall. In some embodiments, if the NE cores are stalling on accesses to local memory 123, e.g., the L2 cache, both the numerator and the denominator of this metric would be small, compared to if they were stalling on accesses to DRAM in which case both the numerator and the denominator would be large.

In some embodiments, Bandwidth is a rate at which computation engine 105 can pull data and measures the extent to which the fabric and memory links are saturated. In some embodiments, bandwidth can be an indication of system memory bandwidth indicator 143. As LLMs continue to evolve and the number of bits needed to represent a weight shrink, parts of a network that were previously memory bound may now scale with the frequency of computation engine 105. Accordingly, variable bandwidth can dynamically identify if there's an efficiency opportunity available based on the bottleneck.

In some embodiments, all 3 metrics above, MACs per Byte, Stalled Cycles per Byte, and Bandwidth can be calculated as filtered averages to provide a smooth control response.

In addition, efficiency control metric 507 can be calculated further based on two more parameters: Arithmetic Intensity Correction Factor 502 and Bandwidth Correction Factor 504. In some embodiments, Arithmetic Intensity Correction Factor can be a piecewise linear curve that takes in MACs per Byte parameter as input and returns a scale factor between 0 and 1. The use of Arithmetic Intensity Correction Factor can conditionally allow the NE cores to stall, provided the set of operations has high arithmetic intensity that would warrant the higher frequency (e.g. during the prompt phase) for computation engine 105. In some embodiments, the parameter Bandwidth Correction Factor can be a piecewise linear curve that takes in Bandwidth as input and returns a scale factor between 0 and 1. The use of Bandwidth Correction Factor can selectively apply efficiency control to only the memory bound portions of the network.

In some embodiments, both correction factors combine multiplicatively and are used to scale Stalled Cycles per Byte to derive the efficiency control metric that is fed as the input to the PI limiter.

In some embodiments, efficiency control metric 507 can be periodically determined with a time period. Furthermore, the periodically determined efficiency control metric 507 can be fed into PI limiter 509 that can produce a control effort that can be looked up in the ANE performance map to determine the NE operating point. In some embodiments, PI limiter 509 can have a floor, e.g., hardware limit parameters 147, e.g., minimal frequency, maximum frequency, target efficiency, for how much it is allowed to push down on performance to maintain a minimum token rate.

FIG. 6B illustrates embodiments of generating target performance adjustment 521 for PI limiter 509.

In some embodiments, PI limiter 509 can adjust operating point 513 based on target performance adjustment 521 that is generated based on performance model 511 used to predict expected runtime. Since computation engine 105 is a dedicated hardware accelerator and not a general purpose compute element, a set of operations of task 111 can be translated into a series of task descriptors complied by compiler 116 before the set of operations can be executed on hardware. Using a built-in performance model, e.g., performance model 511, compiler 116 can calculate various expected execution characteristics for each task descriptor by estimating the cost of each operation of the set of operations of task 111.

In some embodiments, based on the architecture of device 100 as shown in FIG. 1, which can include computation engine 105, controller 103, memory device 101, fabric 107 and fabric 108, neural processing circuit 151, local memory 123, memory controller 109, and other components, compiler 116 can estimate various parameters. The estimated parameters can include the first estimate 513 of a total time for performing the first set of operations 111a by computation engine 105, which can be indicated as a Static NE time; the second estimate 514 of a total time for accessing local memory 123 within computation engine 105 for performing the first set of operations 111a, which can be indicated as a Static L2 time as the total time being spent in accessing L2 cache; the third estimate 515 of a total time for accessing memory device 101 for performing the first set of operations 111a, which can be referred to as Static DRAM time indicating a total time spent accessing memory device 101 that is a DRAM; and the fourth estimate 516 of a total execution time of the first set of operations 111a, which can be a total execution time for executing each task descriptor of the set of operations. In some embodiments, there can be an average read bandwidth 651 that is estimated as well. These statistics can be accumulated across all tasks to provide the analogous estimates for the set of operations 111a.

For each task descriptor, Static NE time, Static L2 time, Static DRAM time, and the total execution time can be are to compute the set of tasks 518 including tasks that can be adjusted for the operating point (leeway fraction, or a fraction of compressible tasks), and also compute the set of tasks 519 including tasks that cannot be adjusted for the operating point (no leeway fraction, or a fraction of incompressible tasks). In some embodiments, leeway fraction, which refers to as the set of tasks 518, and no leeway fraction, which refers to as the set of tasks 519, describe the compressible and incompressible runtime for the task as estimated by the compiler performance model 511. Compressible runtime fraction (the set of tasks 518) describes what fraction of the total task runtime can be slowed down without affecting performance significantly (e.g., more memory bound). Incompressible runtime fraction (the set of tasks 519) describes what fraction of the task cannot be slowed down without affecting performance significantly (e.g., more compute bound). Using the leeway and no leeway fraction at a variety of operating points, a scalability curve for the task can be constructed to inform how much PI limiter 509 can adjust the operating point 513 based on target performance adjustment 521 to meet a power performance tradeoff. In some embodiments, compute leeway fraction and compute no leeway fraction are combined with the estimated bandwidth and execution runtime to optionally adjust the target for PI limiter 509.

$$compute leeway ( task ) = Scaled DRAM Time - max ( Static NE Time , Static L 2 Time )$$

$$compute leeway fraction = \frac{{\sum }_{tasks} max ( compute leeway ( task ) , 0 )}{total execution time}$$

$$compute no leeway fraction = \frac{{\sum }_{tasks} max ( Static NE Time , Static L 2 Time ) \times {1}_{compute leeway ( task ) < 0}}{total execution time}$$

In some embodiments, there can be an additional control to perform an inference of a LLM task such that the inference task can consume the least amount of energy without any performance considerations. This additional degree of control can be achieved by annotating the inference task with an appropriate Quality of Service (QOS) class (e.g. Background or Utility) that can further push down on the operating point of computation engine 105 beyond the floor indicated by hardware limit parameters 147.

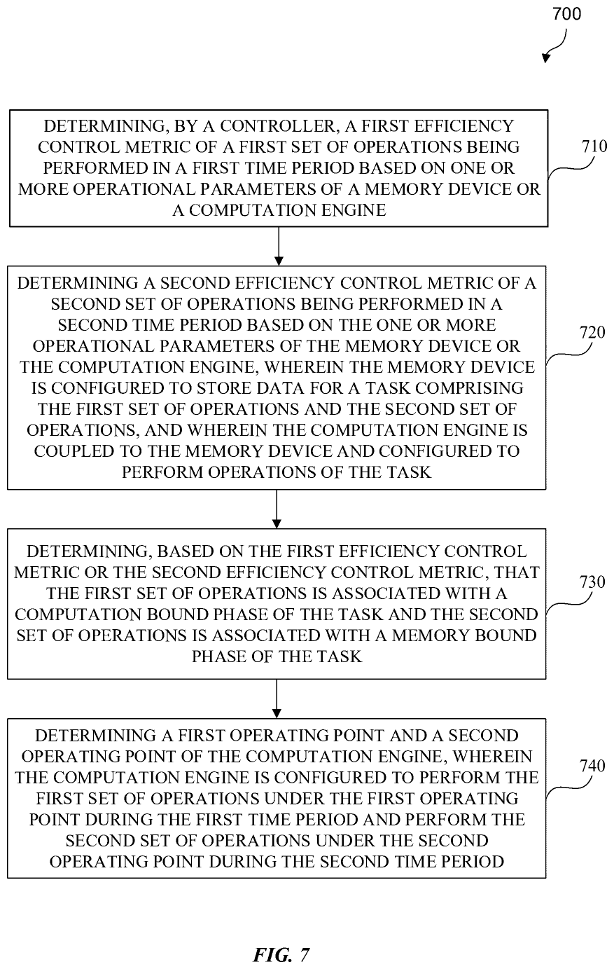

FIG. 7 is an illustration of a method 700 for controlling power performance tradeoffs for a task having computation bound and memory bound phases, according to some embodiments. In some embodiments, method 700 can be performed by controller 103 as shown in FIG. 1A.

At 710, controller 103 can determine a first efficiency control metric 131 of the first set of operations 111a being performed in a first time period based on one or more operational parameters of memory device 101 or computation engine 105.

At 720, controller 103 determine a second efficiency control metric 132 of the second set of operations 111b being performed in a second time period based on the one or more operational parameters of memory device 101 or computation engine 105. In some embodiments, memory device 101 is configured to store data for task 111 including the first set of operations 111a and the second set of operations 111b, and computation engine 105 is configured to perform operations of task 111.

At 730, controller 103 can determine, based on the first efficiency control metric 131 or the second efficiency control metric 132, that the first set of operations 111a is associated with computation bound phase 113 of task 111 and the second set of operations 111b is associated with memory bound phase 115 of task 111.

At 740, controller 103 can determining the first operating point 136 and the second operating point 137 of computation engine 105. Computation engine is configured to perform the first set of operations 111a under the first operating point 136 during the first time period and perform the second set of operations 111b under the second operating point 137 during the second time period.

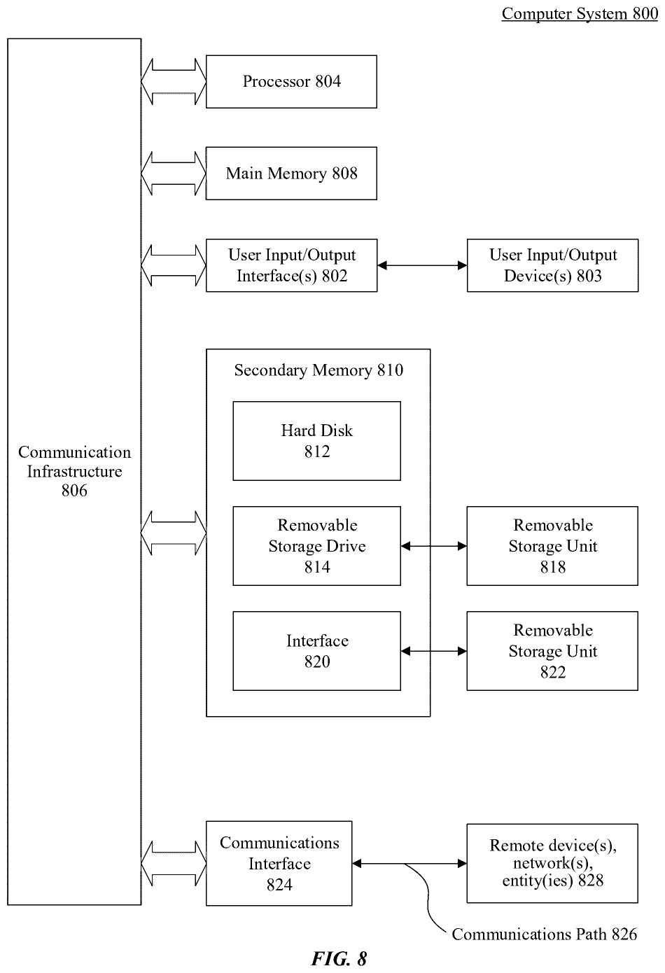

Various aspects can be implemented, for example, using one or more computer systems, such as computer system 800 shown in FIG. 8. Computer system 800 can be any computer capable of performing the functions described herein for device 100 shown in FIGS. 1A-1B and to perform operations described in FIGS. 5, 6A-6B, and 7. Computer system 800 includes one or more processors (also called central processing units, or CPUs), such as a processor 804. Processor 804 is connected to a communication infrastructure 806 (e.g., a bus). Computer system 800 also includes user input/output device(s) 803, such as monitors, keyboards, pointing devices, etc., that communicate with communication infrastructure 806 through user input/output interface(s) 802. Computer system 800 also includes a main or primary memory 808, such as random access memory (RAM). Main memory 808 may include one or more levels of cache. Main memory 808 has stored therein control logic (e.g., computer software) and/or data.

Computer system 800 may also include one or more secondary storage devices or memory 810. Secondary memory 810 may include, for example, a hard disk drive 812 and/or a removable storage device or drive 814. Removable storage drive 814 may be a floppy disk drive, a magnetic tape drive, a compact disk drive, an optical storage device, tape backup device, and/or any other storage device/drive.

Removable storage drive 814 may interact with a removable storage unit 818. Removable storage unit 818 includes a computer usable or readable storage device having stored thereon computer software (control logic) and/or data. Removable storage unit 818 may be a floppy disk, magnetic tape, compact disk, DVD, optical storage disk, and/any other computer data storage device. Removable storage drive 814 reads from and/or writes to removable storage unit 818 in a well-known manner.

According to some aspects, secondary memory 810 may include other means, instrumentalities or other approaches for allowing computer programs and/or other instructions and/or data to be accessed by computer system 800. Such means, instrumentalities or other approaches may include, for example, a removable storage unit 822 and an interface 820. Examples of the removable storage unit 822 and the interface 820 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

In some examples, main memory 808, the removable storage unit 818, the removable storage unit 822 can store instructions that, when executed by processor 804, cause processor 804 to perform operations for device 100 including components, such as processing device or data queue device, as shown in FIGS. 1A-1B, to perform operations described in FIGS. 5A-5B, 6A-6B, and 7.

Computer system 800 may further include a communication or network interface 824. Communication interface 824 enables computer system 800 to communicate and interact with any combination of remote devices, remote networks, remote entities, etc. (individually and collectively referenced by reference number 828). For example, communication interface 824 may allow computer system 800 to communicate with remote devices 828 over communications path 826, which may be wired and/or wireless, and which may include any combination of LANs, WANs, the Internet, etc. Control logic and/or data may be transmitted to and from computer system 800 via communication path 826.

The operations in the preceding aspects can be implemented in a wide variety of configurations and architectures. Therefore, some or all of the operations in the preceding aspects may be performed in hardware, in software or both. In some aspects, a tangible, non-transitory apparatus or article of manufacture includes a tangible, non-transitory computer useable or readable medium having control logic (software) stored thereon is also referred to herein as a computer program product or program storage device. This includes, but is not limited to, computer system 800, main memory 808, secondary memory 810 and removable storage units 818 and 822, as well as tangible articles of manufacture embodying any combination of the foregoing. Such control logic, when executed by one or more data processing devices (such as computer system 800), causes such data processing devices to operate as described herein.

Based on the teachings in this disclosure, it will be apparent to persons skilled in the relevant art(s) how to make and use aspects of the disclosure using data processing devices, computer systems and/or computer architectures other than that shown in FIG. 8. In particular, aspects may operate with software, hardware, and/or operating system implementations other than those described herein.

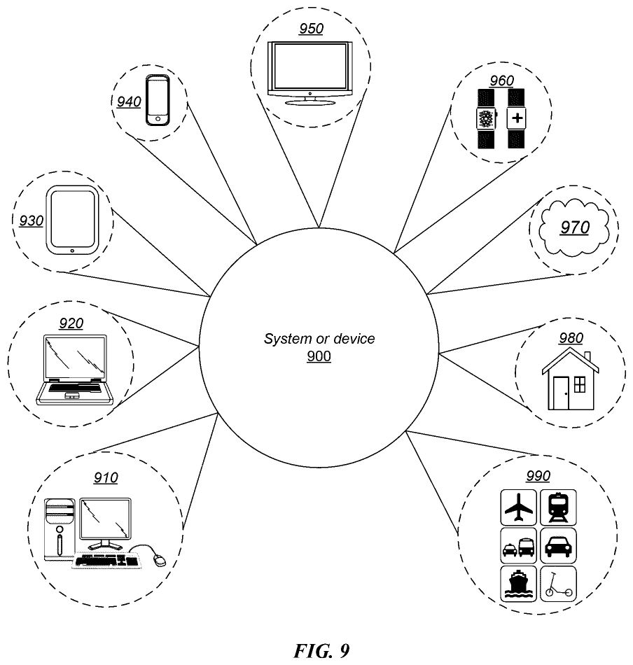

FIG. 9 is an illustration of exemplary systems or devices that can include the disclosed embodiments. System or device 900 can incorporate one or more of the disclosed embodiments in a wide range of areas, such as embodiments described in FIGS. 1A-1B, to perform operations described in FIGS. 5A-5B, 6A-6B, and 7. For example, system or device 900 can be implemented in one or more of a desktop computer 910, a laptop computer 920, a tablet computer 930, a cellular or mobile phone 940, and a television 950 (or a set-top box in communication with a television).

Also, system or device 900 can be implemented in a wearable device 960, such as a smartwatch or a health-monitoring device. In some embodiments, the smartwatch can have different functions, such as access to email, cellular service, and calendar functions. Wearable device 960 can also perform health-monitoring functions, such as monitoring a user's vital signs and performing epidemiological functions (e.g., contact tracing and providing communication to an emergency medical service). Wearable device 960 can be worn on a user's neck, implantable in user's body, glasses or a helmet designed to provide computer-generated reality experiences (e.g., augmented and/or virtual reality), any other suitable wearable device, and combinations thereof.

Further, system or device 900 can be implemented in a server computer system, such as a dedicated server or on shared hardware that implements a cloud-based service 970. System or device 900 can be implemented in other electronic devices, such as a home electronic device 980 that includes a refrigerator, a thermostat, a security camera, and other suitable home electronic devices. The interconnection of such devices can be referred to as the “Internet of Things” (IoT). System or device 900 can also be implemented in various modes of transportation 990, such as part of a vehicle's control system, guidance system, and/or entertainment system.

The systems and devices illustrated in FIG. 9 are merely examples and are not intended to limit future applications of the disclosed embodiments. Other example systems and devices that can implement the disclosed embodiments include portable gaming devices, music players, data storage devices, and unmanned aerial vehicles.

It is noted that references in the specification to “one embodiment,” “an embodiment,” “an example embodiment,” “exemplary,” etc., indicate that the embodiment described can include a particular feature, structure, or characteristic, but every embodiment can not necessarily include the particular feature, structure, or characteristic. Moreover, such phases do not necessarily refer to the same embodiment. Further, when a particular feature, structure or characteristic is described in connection with an embodiment, it would be within the knowledge of one skilled in the art to effect such feature, structure or characteristic in connection with other embodiments whether or not explicitly described.

It is to be understood that the phraseology or terminology herein is for the purpose of description and not of limitation, such that the terminology or phraseology of the present specification is to be interpreted by those skilled in relevant art(s) in light of the teachings herein.

In some embodiments, the terms “about” and “substantially” can indicate a value of a given quantity that varies within 5% of the value (e.g., ±1%, ±2%, ±3%, ±4%, ±5% of the value). These values are merely examples and are not intended to be limiting. The terms “about” and “substantially” can refer to a percentage of the values as interpreted by those skilled in relevant art(s) in light of the teachings herein. Furthermore, the terms “comprising,” “including,” “having,” and the like, as used with respect to embodiments of the present disclosure, are synonymous.

As used hereinafter, including the claims, the term “unit”, “module” or “routine” may refer to, be part of, or include an Application Specific Integrated Circuit (ASIC), an electronic circuit, a processor (shared, dedicated, or group) and/or memory (shared, dedicated, or group) that execute one or more software or firmware programs, a combinational logic circuit, and/or other suitable components that provide the described functionality.

Where the disclosure recites “a” or “a first” element or the equivalent thereof, such disclosure includes one or more such elements, neither requiring nor excluding two or more such elements. Further, ordinal indicators (e.g., first, second or third) for identified elements are used to distinguish between the elements, and do not indicate or imply a required or limited number of such elements, nor do they indicate a particular position or order of such elements unless otherwise specifically stated.

The terms “coupled with” and “coupled to” and the like may be used herein. “Coupled” may mean one or more of the following. “Coupled” may mean that two or more elements are in direct physical or electrical contact. However, “coupled” may also mean that two or more elements indirectly contact each other, but yet still cooperate or interact with each other, and may mean that one or more other elements are coupled or connected between the elements that are said to be coupled with each other. By way of example and not limitation, “coupled” may mean two or more elements or devices are coupled by electrical connections on a printed circuit board, such as a motherboard, for example. By way of example and not limitation, “coupled” may mean two or more elements/devices cooperate and/or interact through one or more network linkages, such as wired and/or wireless networks. By way of example and not limitation, a computing apparatus may include two or more computing devices “coupled” on a motherboard or by one or more network linkages.

It is to be appreciated that the Detailed Description section, and not the Abstract of the Disclosure section, is intended to be used to interpret the claims. The Abstract of the Disclosure section may set forth one or more but not all possible embodiments of the present disclosure as contemplated by the inventor(s), and thus, are not intended to limit the subjoined claims in any way.

The foregoing disclosure outlines features of several embodiments so that those skilled in the art may better understand the aspects of the present disclosure. Those skilled in the art will appreciate that they may readily use the present disclosure as a basis for designing or modifying other processes and structures for carrying out the same purposes and/or achieving the same advantages of the embodiments introduced herein. Those skilled in the art will also realize that such equivalent constructions do not depart from the spirit and scope of the present disclosure, and that they may make various changes, substitutions, and alterations herein without departing from the spirit and scope of the present disclosure.

What is claimed is:

1. A device, comprising:
a memory device configured to store data for a task comprising a first set of operations being performed at a first time period and a second set of operations being performed at a second time period;
a computation engine coupled to the memory device and configured to perform operations of the task comprising the first set of operations and the second set of operations; and
a controller coupled to the memory device and the computation engine and configured to:
determine a first efficiency control metric of the first set of operations or a second efficiency control metric of the second set of operations based on one or more operational parameters of the memory device or the computation engine measured in the first time period or the second time period, respectively;
determine, based on the first efficiency control metric or the second efficiency control metric, that the first set of operations is associated with a computation bound phase of the task and the second set of operations is associated with a memory bound phase of the task; and
determine a first operating point and a second operating point of the computation engine, wherein the computation engine is configured to perform the first set of operations under the first operating point during the first time period and perform the second set of operations under the second operating point during the second time period.

2. The device of claim 1, wherein the computation engine is further configured to:
consume a first power in response to being operated under the first operating point to perform the first set of operations of the computation bound phase; and
consume a second power in response to being operated under the second operating point to perform the second set of operations of the memory bound phase, wherein the first power is larger than the second power.

3. The device of claim 1, wherein the computation engine comprises a communication fabric, a memory controller, a local memory, and a plurality of neural engine circuits configured to perform the operations of the task, and wherein the data stored in the memory device comprises input data and kernel data comprising a plurality of weights.

4. The device of claim 1, wherein the controller is further configured to periodically determine an efficiency control metric of a set of operations of the task, and wherein the first time period is equal to the second time period.

5. The device of claim 1, wherein the task comprises a third set of operations being performed at a third time period, and the controller is further configured to:
determine the third set of operations is associated with the computation bound phase or with the memory bound phase based on a predetermined memory bandwidth threshold and a system memory bandwidth indicator, wherein the system memory bandwidth indicator is based on a ratio of a memory bandwidth used to receive data stored in the memory device for the third set of operations to a link bandwidth capacity between the computation engine and the memory device.

6. The device of claim 5, wherein the memory bandwidth used to receive the data stored in the memory device for the third set of operations is determined based on a number of bits in one or more weights used for the third set of operations.

7. The device of claim 5, wherein the predetermined memory bandwidth threshold has a first value of 50%, and wherein the controller is further configured to determine the third set of operations associated with the computation bound phase in response to the memory bandwidth used to receive the data stored in the memory device for the third set of operations being below the first value in comparison with the link bandwidth capacity; or
the predetermined memory bandwidth threshold has a second value of 90%, and wherein the controller is further configured to determine the third set of operations associated with the memory bound phase in response to the memory bandwidth used to receive the data stored in the memory device for the third set of operations being above the second value in comparison with the link bandwidth capacity.

8. The device of claim 1, wherein the controller is further configured to determine the first operating point and the second operating point of the computation engine based on one or more hardware limit parameters for the computation engine.

9. The device of claim 1, wherein the controller is further configured to determine the first efficiency control metric of the first set of operations based on an arithmetic intensity indicating a number of operations performed by the computation engine during the first time period for the first set of operations, a stall frequency indicating a number of stalls for the computation engine to wait for data comprising input data and kernel data from the memory device during the first time period for the first set of operations, a system memory bandwidth indicator during the first time period for the first set of operations, or a number of memory read count during the first time period to read data for the task from the memory device configured to store the data for the task.

10. The device of claim 9, wherein the controller is further configured to determine the first efficiency control metric of the first set of operations based on an arithmetic intensity correction factor and a bandwidth correction factor both being multiplicatively applied to the stall frequency.

11. The device of claim 1, wherein the controller is further configured to determine the first operating point of the computation engine indicated by a target performance adjustment generated by a compiler based on a task performance model comprising a plurality of tasks previously performed by the computation engine.

12. The device of claim 11, wherein the target performance adjustment is generated based on a first estimate of a total time for performing the first set of operations by the computation engine, a second estimate of a total time for accessing a local memory within the computation engine for performing the first set of operations, a third estimate of a total time for accessing the memory device for performing the first set of operations, and a fourth estimate of a total execution time of the first set of operations, wherein the first estimate, the second estimate, the third estimate, and the fourth estimate are determined based on the task performance model.

13. The device of claim 12, wherein the target performance adjustment is generated based on an estimated system memory bandwidth indicator for the first set of operations determined based on the task performance model.

14. The device of claim 12, wherein the target performance adjustment is generated based on a determination whether a task of the task performance model can be adjusted for an operating point of the computation engine based on a comparison of the third estimate of the total time for accessing the memory device to the first estimate of the total time for performing the first set of operations by the computation engine or based on a comparison of the third estimate of the total time for accessing the memory device to the second estimate of the total time for accessing the local memory within the computation engine.

15. A method, comprising:
determining, by a controller, a first efficiency control metric of a first set of operations being performed in a first time period based on one or more operational parameters of a memory device or a computation engine;
determining a second efficiency control metric of a second set of operations being performed in a second time period based on the one or more operational parameters of the memory device or the computation engine, wherein the memory device is configured to store data for a task comprising the first set of operations and the second set of operations, and wherein the computation engine is coupled to the memory device and configured to perform operations of the task;
determining, based on the first efficiency control metric or the second efficiency control metric, that the first set of operations is associated with a computation bound phase of the task and the second set of operations is associated with a memory bound phase of the task; and
determining a first operating point and a second operating point of the computation engine, wherein the computation engine is configured to perform the first set of operations under the first operating point during the first time period and perform the second set of operations under the second operating point during the second time period.

16. The method of claim 15, further comprising:
consuming, by the computation engine, a first power in response to being operated under the first operating point to perform the first set of operations of the computation bound phase; and
consuming, by the computation engine, a second power in response to being operated under the second operating point to perform the second set of operations of the memory bound phase, wherein the first power is larger than the second power.

17. The method of claim 15, wherein the computation engine comprises a communication fabric, a memory controller, a local memory, and a plurality of neural engine circuits configured to perform the operations of the task, and wherein the data stored in the memory device comprises input data and kernel data comprising a plurality of weights.

18. A system, comprising:
a memory device configured to store data for a task comprising a first set of operations being performed at a first time period and a second set of operations being performed at a second time period;
a computation engine coupled to the memory device and configured to perform operations of the task comprising the first set of operations and the second set of operations, wherein the computation engine comprises a communication fabric, one or more memory controllers configured to control the memory device, a local memory, and a plurality of neural engine circuits configured to perform the operations of the task; and
a controller coupled to the memory device and the computation engine and configured to:
determine a first efficiency control metric of the first set of operations or a second efficiency control metric of the second set of operations based on one or more operational parameters of the memory device or the computation engine measured in the first time period or the second time period, respectively;
determine, based on the first efficiency control metric or the second efficiency control metric, that the first set of operations is associated with a computation bound phase of the task and the second set of operations is associated with a memory bound phase of the task; and
determine a first operating point and a second operating point of the computation engine, wherein the computation engine is configured to perform the first set of operations under the first operating point during the first time period and perform the second set of operations under the second operating point during the second time period.

19. The system of claim 18, wherein the task comprises a third set of operations being performed at a third time period, and wherein the controller is further configured to:
determine the third set of operations is associated with the computation bound phase or with the memory bound phase based on a predetermined memory bandwidth threshold and a system memory bandwidth indicator, wherein the system memory bandwidth indicator is based on a ratio of a memory bandwidth used to receive data stored in the memory device for the third set of operations to a link bandwidth capacity between the computation engine and the memory device.

20. The system of claim 18, wherein the controller is further configured to determine the first efficiency control metric of the first set of operations based on an arithmetic intensity indicating a number of operations performed by the computation engine during the first time period for the first set of operations, a stall frequency indicating a number of stalls for the computation engine to wait for data comprising input data and kernel data from the memory device during the first time period for the first set of operations, a system memory bandwidth indicator during the first time period for the first set of operations, or a number of memory read count during the first time period to read data for the task from the memory device configured to store the data for the task.
